(19) United States
(12) Patent Application Publication
(10) Pub. No.: US 2004/0075700 A1
(43) Pub. Date: Apr. 22, 2004

(54) Functional idle mode display

(76) Inventors: Catherine Liu, Glenview, IL (US); Mang Zhu, Vernon Hills, IL (US)

Correspondence Address: MOTOROLA INC, 600 NORTH US HIGHWAY 45, ROOM AS437, LIBERTYVILLE, IL, 60048-5343, US

(21) Appl. No.: 10/271,431

(22) Filed: Oct. 16, 2002

(51) Int. Cl. G09G 5/00

(52) U.S. Cl. 345/867

(57) ABSTRACT

An apparatus and method for informing a monitored internal system status of an electronic device using a screen saver program is disclosed. When the screen saver program is activated (704), a virtual analog clock (706, 106) having a time-varying visual attribute (108, 110, 112) is displayed. The time-varying visual attribute is varied to indicate the status of the monitored internal system status during the time the screen saver program is active.

### FIELD OF THE INVENTIONS

The present inventions relate to electronic devices having displays and methods therefor. More specifically, the present inventions relate to apparatuses and methods for graphically providing users with system status information of the electronic devices while the electronic devices operate in screen saver mode.

### BACKGROUND OF THE INVENTIONS

Today, an electronic device having a display such as a desktop computer, laptop computer, cellular telephone, and personal digital assistant (“PDA”), normally contains a screen saver program. The screen saver program is generally activated after the electronic device has remained inactive for a predetermined period of time, or is activated manually to save power and to save the screen itself from being permanently burned by a constant and unchanged display. The screen saver program may turn off the screen completely, or may display a simple set of moving graphics to reduce power consumption and likelihood of screen burns. For a battery powered electronic device such as a cellular telephone and a PDA, the power saving may significantly increase the battery life. However, once the electronic device enters the screen saver mode, the screen of the electronic device conveys very little information.

### BRIEF DESCRIPTION OF THE DRAWINGS

FIG. 1 is a first exemplary embodiment of the present invention.

FIG. 2 is an exemplary display of the electronic device indicating the status of a monitored internal system by varying the size of the first aspect of the visual attribute.

FIG. 3 is an exemplary display of the electronic device indicating the status of a monitored internal system by varying the shape of the first one aspect of the visual attribute.

FIG. 4 is an exemplary display of the electronic device indicating the status of a monitored internal system by varying the size of the second aspect of the visual attribute.

FIG. 5 is an exemplary display of the electronic device indicating the status of a monitored internal system by varying the shape of the second aspect of the visual attribute.

FIG. 6 is an exemplary display of the electronic device indicating the status of two monitored internal systems by varying the size of the first aspect of the visual attribute and varying the shape of the second aspect of the visual attribute.

FIG. 7 is an exemplary flowchart of the present invention.

### DETAILED DESCRIPTION OF THE INVENTIONS

The present invention is an apparatus and method for providing internal system status of an electronic device using a screen saver display. The present invention monitors the selected internal system status of the electronic devise such as, but not limited to, the battery charge level and the received signal strength, and displays the monitored status as a part of the screen saver display.

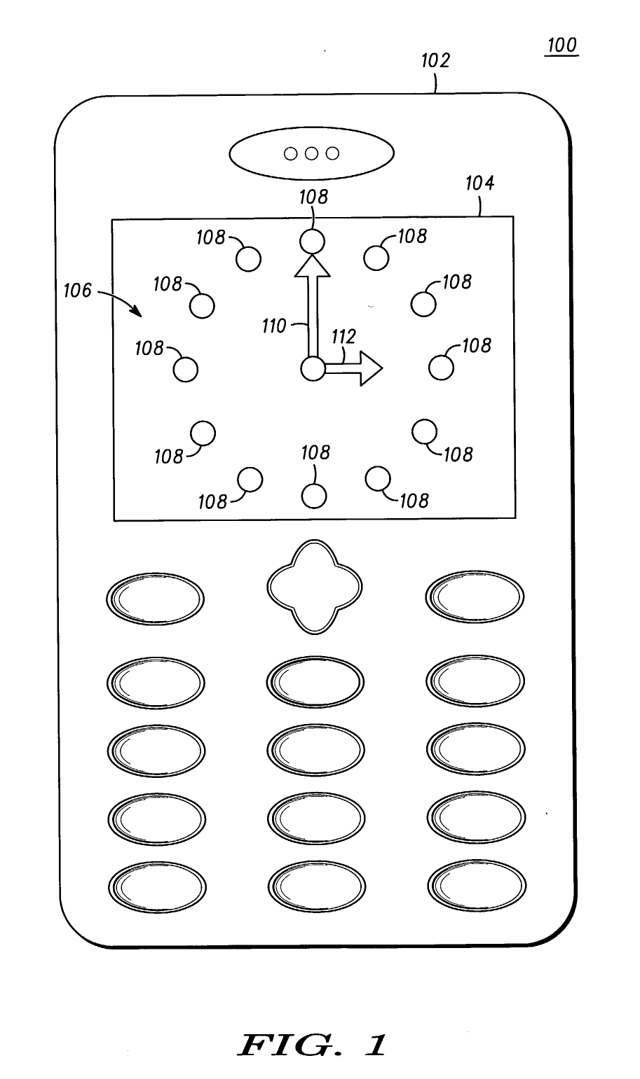

Referring to FIG. 1, there is provided a first embodiment of the present invention. Although an electronic device 102 is shown with a display 104 having a virtual analog clock 106 as a screen saver display, the displayed clock need not be limited to an analog clock. Disposed on the virtual analog clock are a plurality of hour markers 108 (twelve shown), an hour hand 110, and a minute hand 112 indicating the current time (three o'clock shown). The virtual analog clock includes a visual attribute which changes in response to a changing status of the monitored internal system status. For example, the visual attribute for monitoring the battery charge level, may be set with five discrete levels (100%, 75%, 50%, 25%, and 0%) which correspond to five distinct visual attribute appearances. The status of the battery 100% charged is shown by the full lengths of the hour and minute hands in FIG. 1. However, the visual attribute may be associated with any parts and characteristics of the clock being displayed in the screen saver such as, but not limited to, numbers used to display a digital clock, and a location, size, color, contrast, and shape of the clock being displayed.

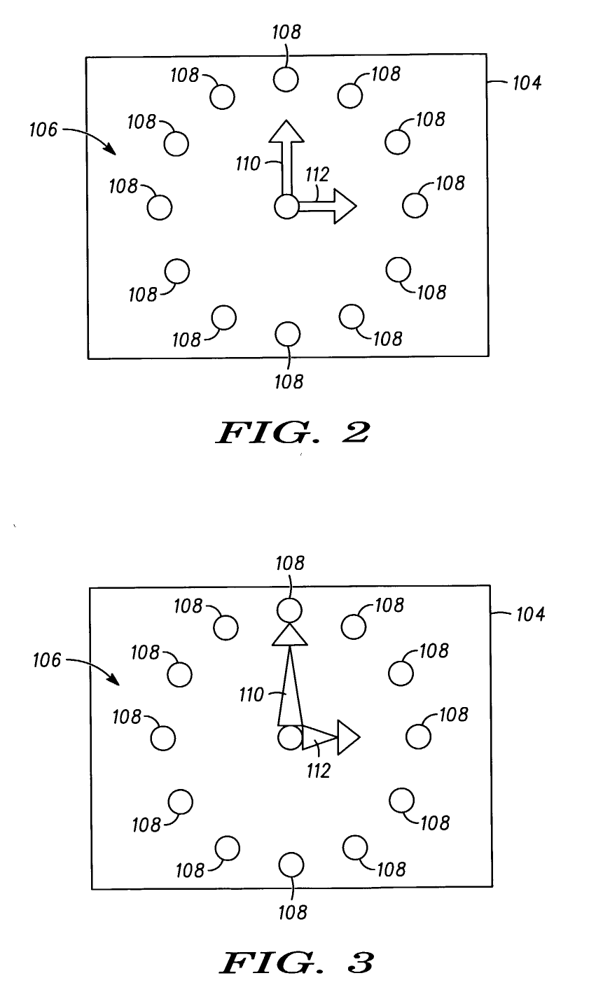

FIG. 2 shows the display 104 of the electronic device indicating the status of the battery 50% charged by displaying the virtual clock 106 with shorter hour hand 110 and minute hand 112 compared to the virtual clock of FIG. 1. As the battery charge decreases and reaches the next level of 25% charge level, the displayed lengths of the hour and minutes hands correspondingly decrease.

FIG. 3 also shows the display 104 of the electronic device indicating the status of the battery 50% charged but by displaying the virtual clock 106 with the shapes of hour hand 110 and minute hand 112 different from the virtual clock of FIG. 1. Different shapes may be assigned to different battery charge levels, and be displayed to reflect the monitored battery level. Contrast and color as well as size and shape of the hour and minute hands may be varied as a visual attribute to indicate the changes in the monitored internal system status. For example, as the battery charge level decreases, the hour and minute hands may be made to appear fainter, or the hour and minute hand may be changed to more vivid color from black to green to yellow to red.

Instead of using the hour and minute hands, the hour markers 108 may be used to indicate the changes. FIG. 4 shows the display 104 of the electronic device indicating the status of the battery 50% charged by displaying the virtual clock 106 with the hour markers as semi-circles instead of full circles as with the virtual clock of FIG. 1. As the battery charge decreases and reaches the next level of 25% charge level, the hour markers change to quarter circles.

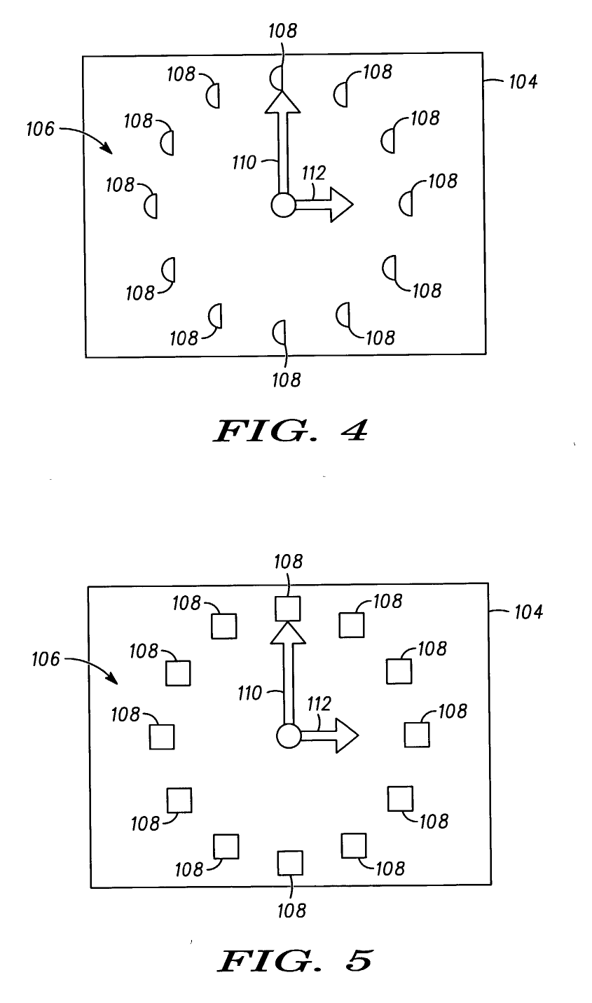

FIG. 5 also shows the display 104 of the electronic device indicating the status of the battery 50% charged but by displaying the virtual clock 106 with the shapes of the hour marker different from the virtual clock of FIG. 1. Different shapes may be assigned to different battery charge levels, and be displayed to reflect the monitored battery level. Contrast and color as well as size and shape of the marker may be varied as a visual attribute to indicate the changes in the monitored internal system status. For example, as the battery charge level decreases, the hour marker may be made to appear fainter, or the hour markers may be changed to more vivid color from black to green to yellow to red.

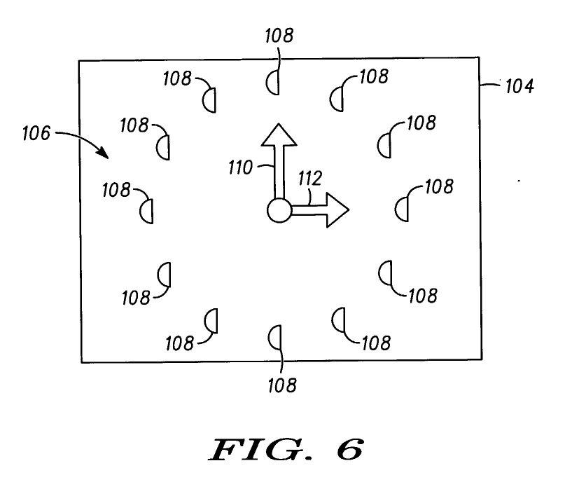

More than one internal system status may be monitored and be displayed. For example, the battery charge level may be indicated by varying the visual attribute of the hour and minute hands while the received signal level is indicated by varying the visual attribute of the hour markers as shown in FIG. 6.

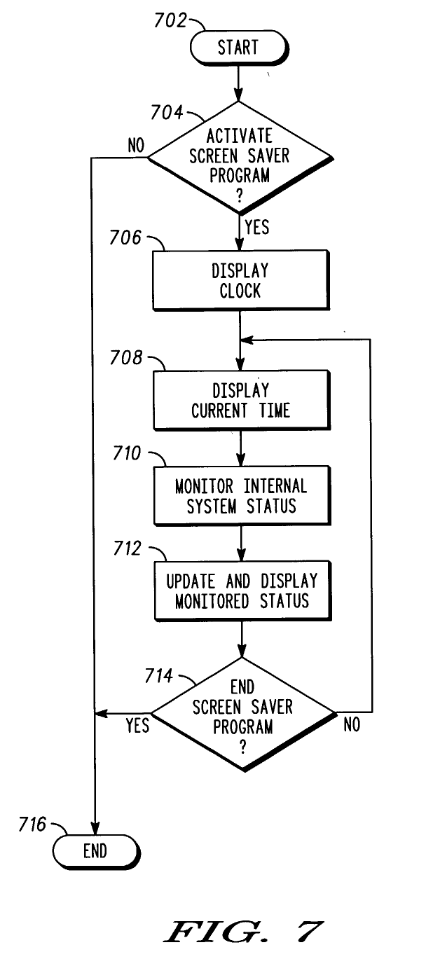

FIG. 7 illustrates an exemplary flowchart of the present invention. An electronic device running a screen saver program determines whether to activate the screen saver program based upon a predetermined condition such as inactivity for a certain period of time in block 704. If the screen saver program is not activated at this time, the wireless communication device resumes its normal operation and may continue to monitor the predetermined condition. If the screen saver program is activated, then a clock having a visual attribute is displayed in block 706 and the clock displays the current time in block 708. An internal system status such as the battery charge level and the received signal level is monitored in block 710, and the monitored system status is displayed by varying the visual attribute in block 712. The varying of the visual attribute may be realized by visually varying the parts of the clock such as, but not limited to, the size, shape, color, and contrast of the hour and minute hands and hour markers. The wireless communication device then determines whether to terminate the screen saver program in block 714. If the screen saver program is terminated, then the wireless communication device resumes its normal operation in block 716. If the screen saver program is kept active, then the process repeats from block 708.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. An electronic device having a display operable in a screen saver mode, comprising:
a clock disposed on the display when the electronic device is in screen saver mode; and
the clock having an electronic device status visual attribute that changes with changes in a monitored internal system of the electronic device,
the clock indicative of current time.

2. The electronic device of claim 1, the clock is a virtual analog clock, the virtual analog clock having a minute hand having a minute position, an hour hand having an hour position, and a plurality of hour markers.

3. The electronic device of claim 2, the electronic device status visual attribute is the size of the minute hand and hour hand, the minute hand and the hour hand having a first size indicative of a first status of the monitored internal system, and the minute hand and the hour hand having a second size indicative of a second status of the monitored internal system.

4. The electronic device of claim 2, the electronic device status visual attribute is the shape of the minute hand and hour hand, the minute hand and the hour hand having a first shape indicative of a first status of the monitored internal system, and the minute hand and the hour hand having a second shape indicative of a second status of the monitored internal system.

5. The electronic device of claim 2, the electronic device status visual attribute is the contrast of the minute hand and hour hand, the minute hand and the hour hand having a first contrast indicative of a first status of the monitored internal system, and the minute hand and the hour hand having a second contrast indicative of a second status of the monitored internal system.

6. The electronic device of claim 2, the electronic device status visual attribute is the color of the minute hand and hour hand, the minute hand and the hour hand having a first color indicative of a first status of the monitored internal system, and the minute hand and the hour hand having a second color indicative of a second status of the monitored internal system.

7. The electronic device of claim 2, the electronic device status visual attribute is the size of the plurality of hour markers, the plurality of hour markers having a first size indicative of a first status of the monitored internal system, and having a second size indicative of a second status of the monitored internal system.

8. The electronic device of claim 1, the electronic device status visual attribute is the shape of the plurality of hour markers, the plurality of hour markers having a first shape indicative of a first status of the monitored internal system, and having a second shape indicative of a second status of the monitored internal system.

9. The electronic device of claim 1, the electronic device status visual attribute is the contrast of the plurality of hour markers, the plurality of hour markers having a first contrast indicative of a first status of the monitored internal system, and having a second contrast indicative of a second status of the monitored internal system.

10. The electronic device of claim 1, the electronic device status visual attribute is the color of the plurality of hour markers, the plurality of hour markers having a first color indicative of a first status of the monitored internal system, and having a second color indicative of a second status of the monitored internal system.

11. The electronic device of claim 1, the monitored internal system is a battery charge level.

12. The electronic device of claim 1, the monitored internal system is a received signal strength.

13. A method in an electronic device having a display, comprising:
activating a screen saver mode of operation;
displaying a clock having an electronic device status visual attribute;
communicating time with the clock;
monitoring an internal system; and
providing information about the monitored internal system by varying the electronic device status visual attribute of the clock.

14. The method of claim 13, displaying the clock by displaying at least one hand.

15. The method of claim 13, displaying the clock by displaying a time marker.

16. The method of claim 13, varying the electronic device status visual attribute of the clock by varying the size of the electronic device status visual attribute indicative of the status of the monitored internal system.

17. The method of claim 13, varying the electronic device status visual attribute of the clock by varying the shape of the electronic device status visual attribute indicative of the status of the monitored internal system.

18. The method of claim 13, varying the electronic device status visual attribute of the clock by varying the contrast of the electronic device status visual attribute indicative of the status of the monitored internal system.

19. The method of claim 13, varying the electronic device status visual attribute of the clock by varying the color of the electronic device status visual attribute indicative of the status of the monitored internal system.
